(19) United States
(12) Patent Application Publication
(10) Pub. No.: US 2025/0327692 A1
(43) Pub. Date: Oct. 23, 2025

(54) INTEGRATED DISTRIBUTED FIBER OPTIC SENSING SYSTEM FOR ENHANCED OFFSHORE WIND TURBINE MONITORING USING PHYSICS-INFORMED MACHINE LEARNING ALGORITHMS

(71) Applicant: NEC Laboratories America, Inc., Princeton, NJ (US)

(72) Inventors: Yangmin DING, East Brunswick, NJ (US); Ting WANG, West Windsor, NJ (US)

(73) Assignee: NEC Laboratories America, Inc., Princeton, NJ (US)

(21) Appl. No.: 18/935,513

(22) Filed: Nov. 2, 2024

Related U.S. Application Data
(60) Provisional application No. 63/595,972, filed on Nov. 3, 2023.
(60) Provisional application No. 63/567,126, filed on Mar. 19, 2024.

(51) Int. Cl. G01D 5/353; F03D 17/00; G01M 7/02

(52) U.S. Cl. CPC G01D 5/35358; F03D 17/005; G01M 7/025

(57) ABSTRACT

Disclosed is an integrated DFOS system and method for enhanced offshore wind turbine monitoring using physics-informed machine learning algorithms that advantageously utilizes existing optical fiber communication cables, distributed fiber optic sensing (DFOS), Physics-informed machine learning algorithms, monitoring of critical underwater components, integrated data processing (DPU), and comprehensive monitoring.

### CROSS-REFERENCE TO RELATED APPLICATIONS

This application claims the benefit of U.S. Provisional Patent Application Ser. No. 63/595,972 filed Nov. 3, 2023, and U.S. Provisional Patent Application Ser. No. 63/567,126 filed Mar. 19, 2024, the entire contents of each of which is incorporated by reference as if set forth at length herein.

### FIELD OF THE INVENTION

This application relates generally to distributed fiber optic sensing (DFOS) systems, methods, structures, and related technologies. More particularly, it pertains to an integrated DFOS system for enhanced offshore wind turbine monitoring using physics-informed machine learning algorithms.

### BACKGROUND OF THE INVENTION

Distributed fiber optic sensing (DFOS) systems, methods, and structures have found widespread utility in contemporary industry and society. Of particular importance, DFOS techniques have been used to usher in a new era of monitoring including perimeter security, traffic monitoring, and civil infrastructure monitoring. They can provide continuous, real-time measurements over long distances with high sensitivity, making them valuable tools for infrastructure monitoring and maintenance.

Offshore wind turbines play a pivotal role in sustainable energy generation. However, their operation and maintenance present significant challenges due to their location and the associated environmental conditions. The offshore environment subjects these turbines and their associated components to harsh and often unpredictable conditions including saltwater corrosion, strong wave action, and turbulent winds. These conditions can lead to faster wear and tear, potential damage, and system failures.

### SUMMARY OF THE INVENTION

An advance in the art is made according to aspects of the present disclosure directed to an integrated DFOS system for enhanced offshore wind turbine monitoring using physics-informed machine learning algorithms.

In sharp contrast to the prior art, systems and methods according to aspects of the present disclosure provide a number of inventive features in combination including Utilization of Existing Optical Fiber Communication Cables; Distributed Fiber Optic Sensing (DFOS); Physics-Informed Machine Learning Algorithms; Monitoring of Critical Underwater Components; Integrated Data Processing Unit (DPU); and Comprehensive Monitoring.

### Utilization of Existing Optical Fiber Communication Cables

Systems and methods according to the present disclosure ingeniously transform existing optical fiber communication cables into a comprehensive sensor network. This dual-purpose approach ensures no additional infrastructure is needed, making the system cost-effective and reducing installation complexity.

### Distributed Fiber Optic Sensing (DFOS)

Systems and methods according to the present disclosure employ DFOS technology that provides real-time, high-resolution monitoring capabilities. By capturing detailed data on parameters like temperature, strain, acoustics, and vibration, it enables precise monitoring of critical components. The technology's ability to allow simultaneous communication and sensing over extended distances is particularly advantageous for vast offshore operations.

### Physics-Informed Machine Learning Algorithms

Systems and methods according to aspects of the present disclosure introduce advanced machine learning algorithms such as Physics-Informed Neural Networks (PINNs), Hybrid Kalman Neural Networks, and Finite Element Method (FEM)-based Learning. These algorithms, informed by the physical properties and behaviors of turbine components, can interpret intricate patterns in the data. They distinguish between routine operational data and anomalies that hint at potential faults or damages. The fusion of real-time sensing data with these specialized algorithms ensures precise and early fault detection, curtailing false alarms and redundant maintenance operations.

### Focus on Critical Underwater Components

Systems and methods according to aspects of the present disclosure emphasize monitoring mooring lines/anchors, potential collision incidents with underwater debris or smaller vessels, and high-voltage underwater cables. These components are especially vulnerable in offshore environments, and their efficient monitoring is crucial for overall turbine health.

### Integrated Data Processing (DPU)

Systems and methods according to aspects of the present disclosure employ integrated data processing that may be provided by any or all of a variety of computer/processor types. The DPU is where the DFOS data is interpreted and analyzed in real-time. Its ability to process vast amounts of data quickly and provide actionable insights is key to ensuring timely interventions.

### Comprehensive Monitoring

Systems and methods according to aspects of the present disclosure convert communication cables into sensor networks. As a result, our systems and methods can advantageously monitor a wide array of components across vast distances. This comprehensive monitoring approach ensures no component is left unchecked, enhancing overall system reliability

### BRIEF DESCRIPTION OF THE DRAWING

FIG. 1 is a schematic diagram showing an illustrative offshore wind monitoring system using DFOS and physics-informed artificial intelligence according to aspects of the present disclosure.

FIG. 2 is a schematic flow diagram showing illustrative features and relationships or sequences of operation of systems and methods according to aspects of the present disclosure.

FIG. 3 is a schematic diagram showing illustrative features of systems and methods according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

A generalized arrangement and operation of a distributed fiber optic sensing system that may advantageously include artificial intelligence/machine learning (AI/ML) analysis and an optical sensing fiber that in turn is connected to an interrogator. The interrogator may include a coded DFOS system that may employ a coherent receiver arrangement known in the art.

As is known, contemporary interrogators are systems that generate an input signal to the optical sensing fiber and detects/analyzes reflected/backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Of particular interest, distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows for continuous monitoring over long distances, but instead of measuring temperature, it measures vibrations and sounds along the fiber.

DAS/DVS operates as follows.

Light pulses are sent through the fiber optic sensor cable.

As the light travels through the cable, vibrations and sounds cause the fiber to stretch and contract slightly.

These tiny changes in the fiber's length affect how the light interacts with the material, causing a shift in the backscattered light's frequency.

By analyzing the frequency shift of the backscattered light, the DAS/DVS system can determine the location and intensity of the vibrations or sounds along the fiber optic cable.

Similar to DTS, DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technology has a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

With the above in mind, we note once more that traditional wind turbine monitoring methods often rely on a limited set of sensors, such as vibration sensors, temperature sensors, and anemometers. These sensors provide valuable data, but their coverage is limited to specific points on the turbine. They can miss critical signs of potential issues in areas they don't cover. Additionally, these sensors often operate in isolation, meaning they don't share data with each other. This can lead to a lack of context in the data, making it harder to detect complex issues that affect multiple parts of the turbine.

We again note that offshore wind turbines play a pivotal role in sustainable energy generation. However, their operation and maintenance present significant challenges due to their location and the associated environmental conditions. The offshore environment subjects these turbines and their associated components to harsh and often unpredictable conditions, such as saltwater corrosion, strong waves, and turbulent winds. This can lead to faster wear and tear, potential damages, and system failures. Core challenges include the following.

### Human Safety Concerns

The offshore environment is inherently hazardous. Maintenance personnel face risks associated with working at heights, underwater, and working near high-voltage components. Unpredictable weather and sea conditions can further exacerbate these risks. Human interventions under such conditions can lead to accidents, injuries, or even fatalities.

### Operational Efficiency

Damage to, or faults within wind turbine components can lead to operational interruptions or shutdowns, causing significant energy generation losses. Reactive maintenance, where issues are addressed only after they manifest, often requires longer downtime and can result in higher repair costs.

### Difficulty in Early Detection

Given the vast expanse of the offshore environment and the distributed nature of wind farms, early detection of faults or damages is not straightforward. Without continuous monitoring, minor issues can escalate into major damage, complicating repairs and increasing associated costs.

### Limitations of Current Monitoring Systems

Traditional monitoring systems might not offer the granularity required to detect incipient faults, especially in critical components like mooring lines, anchors, underwater cables, and the turbine/hull interface. Current systems might require manual inspections, which again expose maintenance personnel to the above-noted risks and might not provide real-time insights.

Given these challenges, systems and methods according to aspects of the present disclosure provide advanced monitoring of offshore wind systems by at least the following mechanisms.

Continuously monitoring the health and status of offshore wind turbines and their associated components.

Detecting incipient faults or damages at an early stage thereby preventing potential system failures and reducing maintenance downtime.

Reducing the need for human intervention, thereby minimizing human exposure to the hazardous conditions associated with offshore maintenance tasks.

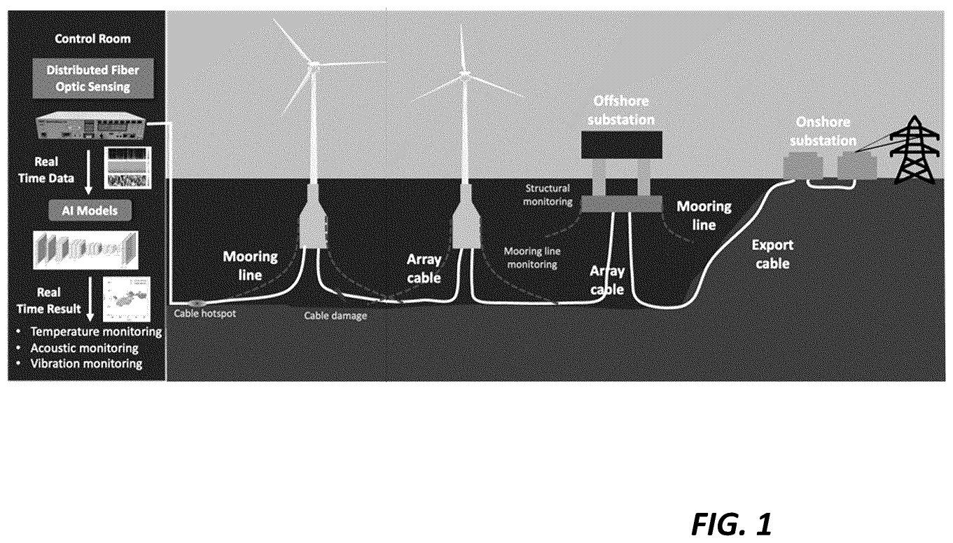

FIG. 1 is a schematic diagram showing an illustrative offshore wind monitoring system using DFOS and physics-informed artificial intelligence according to aspects of the present disclosure.

As illustratively shown in this figure, systems and methods according to aspects of the present disclosure may revolutionize offshore wind turbine monitoring by inventively integrating Distributed Fiber Optic Sensing (DFOS) technology with the existing optical fiber communication cables used in offshore wind operations. By converting these communication cables into a comprehensive sensor network, the system offers real-time, high-resolution monitoring of critical underwater components of offshore wind turbines. The DFOS technology, a cornerstone of our inventive systems and methods, uniquely facilitates simultaneous communication and sensing over extended distances, making it especially advantageous for vast offshore wind farm operations. This sensing capability provides intricate data on parameters like temperature, strain, acoustics, and vibration, which are vital for early detection of potential faults or damages. Specifically, the focus is on monitoring mooring lines/anchors, collision incidents with underwater debris or smaller vessels, and high-voltage underwater cables, including the pivotal export cable bridging offshore and onshore substations.

To decipher intricate data and to distinguish between routine and anomalous events, the system employs novel physics-informed machine learning algorithms, ensuring accurate and timely fault detection while minimizing false alarms.

Particularly inventive features of systems and methods according to aspects of the present disclosure that directly contribute to solving challenges of offshore wind turbine maintenance and monitoring include the following.

### Utilization of Existing Optical Fiber Communication Cables

Systems and methods according to aspects of the present disclosure ingeniously transform existing optical fiber communication cables into a comprehensive sensor network. This dual-purpose approach ensures no additional infrastructure is needed, making the system cost-effective and reducing installation complexity.

### Distributed Fiber Optic Sensing (DFOS)

Systems and methods according to aspects of the present disclosure advantageously employ DFOS technology that provides real-time, high-resolution monitoring capabilities. By capturing detailed data on parameters like temperature, strain, acoustics, and vibration, it enables precise monitoring of critical components. The technology's ability to allow simultaneous communication and sensing over extended distances is particularly advantageous for vast offshore operations.

### Physics-Informed Machine Learning Algorithms

Systems and methods according to aspects of the present disclosure employ advanced machine learning algorithms such as Physics-Informed Neural Networks (PINNs), Hybrid Kalman Neural Networks, and Finite Element Method (FEM)-based Learning. These algorithms, informed by the physical properties and behaviors of turbine components, can interpret intricate patterns in the data. They distinguish between routine operational data and anomalies that hint at potential faults or damages. The fusion of real-time sensing data with these specialized algorithms ensures precise and early fault detection, curtailing false alarms and redundant maintenance operations.

### Focus on Critical Underwater Components

The system emphasizes monitoring mooring lines/anchors, potential collision incidents with underwater debris or smaller vessels, and high-voltage underwater cables. These components are especially vulnerable in offshore environments, and their efficient monitoring is crucial for overall turbine health.

### Integrated Data Processing (DPU)

DFOS data is interpreted and analyzed in real-time. Its ability to process vast amounts of data quickly and provide actionable insights is key to ensuring timely interventions.

### Comprehensive Monitoring

Systems and methods according to aspects of the present disclosure convert communication cables into sensor networks. As a result Systems and methods according to aspects of the present disclosure may monitor a wide array of components across vast distances. This comprehensive monitoring approach ensures no component is left unchecked, enhancing overall system reliability.

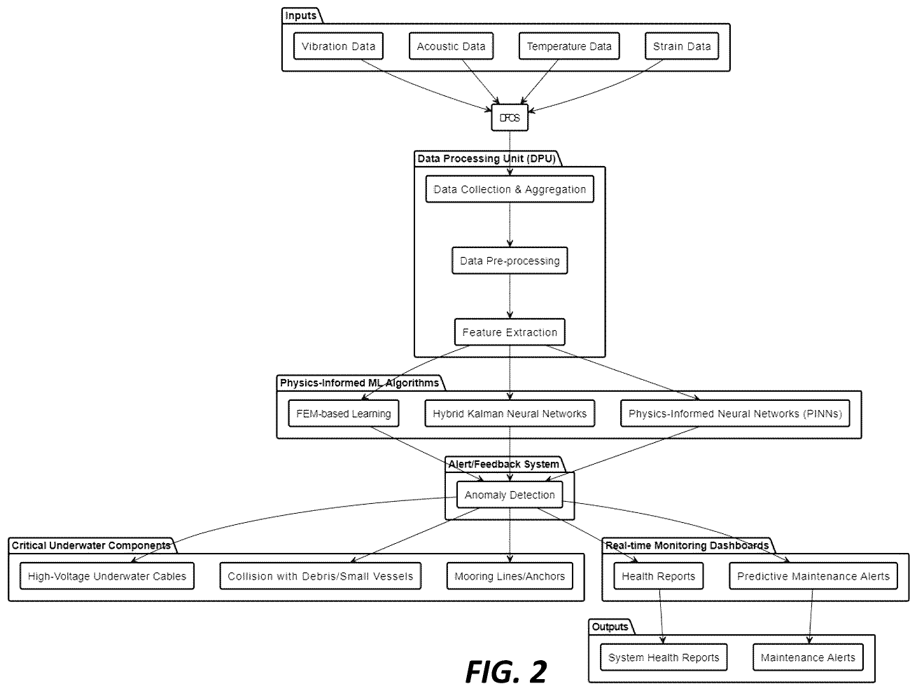

FIG. 2 is a schematic flow diagram showing illustrative features and relationships or sequences of operation of systems and methods according to aspects of the present disclosure.

Upon inspecting the figures, one skilled in the art will understand and appreciate several distinguishing aspects and advantages of systems and methods according to aspects of the present disclosure as well as operational steps and sequences.

Step 1: Integration with Offshore Wind Turbine Infrastructure

Survey and Access: Conduct a detailed survey of the offshore wind turbine farm to locate and access all existing optical fiber communication cables. Understand their layout, lengths, and integration points within the turbine structures and underwater components.

Integration with DFOS: Interface the identified optical fiber cables with the Distributed Fiber Optic Sensing (DFOS) system. This process might involve installing specific connectors, modulators, or repeaters optimized for DFOS functionality.

Calibration for Offshore Monitoring: Once integrated, calibrate the DFOS system specifically for offshore wind turbine monitoring. This includes setting baselines for typical vibrations, acoustics, and other parameters specific to offshore turbines, considering factors like wave actions, tidal movements, and interactions with floating platforms (if present).

### Step 2: Data Acquisition Via DFOS

The DFOS system is activated to continuously monitor and gather real-time data from various wind turbine components. For critical underwater components the following activities are performed.

Mooring Lines/Anchors: Use strain data from DFOS to determine stress and strain on these components. The Physics of material elasticity and mechanical stress-strain relationships help interpret this data.

High-Voltage Underwater Cables: Monitor temperature and acoustic data. Overheating or irregular acoustics (indicative of arcing or breakdown) can be linked to physical principles of electrical conductivity and heat dissipation.

Potential Collision Detection: Monitor vibration and acoustic data. Sudden spikes in data can indicate collisions. The physics of wave propagation and collision mechanics help assess impact severity.

### Step 3: Secure and Efficient Data Transmission to Data Processing (DPU)

Initiation of Data Transmission: Once the DFOS system captures the required data from various turbine components, initialize the data transmission process to the Integrated Data Processing Unit (DPU).

### Addressing Offshore Transmission Challenges:

Bandwidth Constraints: Offshore environments might have limited bandwidth due to the long distances and potential interference. Ensure the data is compressed efficiently without losing critical information before transmission.

Signal Attenuation: Given the considerable distances and potential physical obstructions in offshore setups, there could be signal attenuation. Use repeaters or signal boosters at strategic locations to ensure the data signal remains robust.

Environmental Interferences: Offshore conditions, such as storms or heavy seas, can interfere with data transmission. Implement error-correction codes and algorithms to detect and correct any corrupted data packets during transmission.

Data Encryption for Security: Given the critical nature of the data concerning turbine health and potential commercial implications, encrypt the data during transmission. This ensures protection from potential cyber-attacks or unauthorized access.

Real-time Monitoring of Data Flow: Establish a real-time monitoring system to track data flow from the DFOS to the DPU. Any interruption or delay in data transmission should trigger immediate alerts.

Data Integrity Checks: Once the data reaches the DPU, perform integrity checks to confirm that there's no data loss, corruption, or alteration during transmission. Use checksums or hash functions to validate the integrity of the received data.

Feedback Mechanism: If the DPU detects any anomalies in the received data or if there's missing data, it should send feedback to the DFOS system, prompting re-transmission or specific checks at the source.

Redundant Data Transmission Paths: Given the critical nature of monitoring offshore wind turbines, set up redundant data transmission paths. If one path faces issues, the system should automatically switch to an alternative path, ensuring continuous data flow.

### Step 4: In-Depth Data Pre-Processing at DPU

Signal Filtering: Given the dynamic offshore environment, the raw data might contain noise from waves or other sources. Use advanced filtering techniques, such as wavelet transforms or adaptive filters, to isolate and remove this noise.

Normalization: With varying conditions, the data ranges can fluctuate. Normalize data to a consistent scale to aid in comparison and analysis.

### Step 5: Detailed Application of Physics-Informed Machine Learning Algorithms

Understanding the Physical Context: Before applying any algorithm, it's crucial to have an in-depth understanding of the physical properties and behaviors of the turbine components. This includes material properties, structural dynamics, fluid dynamics (for underwater components), and thermodynamics (for temperature-related aspects).

### Physics-Informed Neural Networks (PINNs)

Integration with Physics Laws: PINNs are designed to incorporate governing physical equations, like Navier-Stokes for fluid flow or heat transfer equations, directly into the neural network structure.

Training Process: Train PINNs with both historical data and synthetic data generated using physics-based simulations. This ensures the model learns from real operational data while staying consistent with physical laws.

Prediction and Analysis: Use PINNs to make predictions about component behaviors and to detect anomalies that violate physical expectations.

### Hybrid Kalman Neural Networks

Combining Best of Both Worlds: This algorithm combines the adaptive capabilities of neural networks with the predictive power of Kalman filters, which are grounded in system dynamics and physical behaviors.

Real-time State Estimation: Use Hybrid Kalman Neural Networks for real-time state estimation of turbine components, providing both current status and predictions based on known physical behaviors.

### Finite Element Method (FEM)-Based Learning

Structural Analysis: Leverage the strength of FEM, commonly used for solving complex structural problems, and integrate it with machine learning. This approach is particularly useful for predicting stress distributions, deformations, and potential points of failure in turbine structures.

Training with Sparse Data: FEM-based learning can be particularly useful when there's limited real-world data available. By integrating FEM simulations into the learning process, the model can be trained and validated against a rich set of physics-based synthetic data.

### Continuous Model Refinement

Feedback Loop with DFOS Data: Continuously refine the physics-informed machine learning models using new data from the DFOS system. This ensures that the models remain up-to-date with any changes in turbine behaviors or conditions.

Physics-based Validation: Periodically validate the machine learning predictions with physics-based simulations to ensure the models remain consistent with physical expectations.

### Step 6: Comprehensive Anomaly Detection and Analysis

Threshold Setting: Establish physics-based thresholds for each monitored parameter. For instance, set temperature thresholds based on material properties and anticipated operational conditions.

Pattern Recognition: Beyond threshold checks, use the trained models to recognize anomalous patterns indicating potential issues, such as wear and tear or impending component failures.

Root Cause Analysis: If anomalies are detected, perform a root cause analysis, integrating physics-based simulations, when necessary, to pinpoint the source and nature of the issue.

### Step 7: Advanced Real-Time Monitoring Dashboards

Visualization Techniques: Use advanced visualization techniques, like 3D modeling or heat maps, to represent data in a manner that's intuitive for operators. For example, visually highlight areas of the turbine experiencing stress or high temperatures.

Interactive Features: Allow operators to interact with the dashboard, zooming into areas of interest, querying data, or running simulations to predict future conditions based on current data.

### Step 8: Proactive Alert and Feedback Mechanism

Priority-based Alerts: Classify alerts based on severity and potential impact. For instance, a minor temperature increase might be a low-priority alert, while a significant structural strain could trigger a high-priority alarm.

Feedback to Operators: Provide detailed feedback on detected issues, including potential causes, recommended actions, and any relevant physics-based insights or predictions.

### Step 9: Continuous Learning and Iteration

Model Refinement: As more data is collected and as the turbine ages or undergoes maintenance, continuously refine and retrain the machine learning models to keep them up-to-date.

Operational Feedback Loop: Use insights from the system to inform maintenance strategies, operational adjustments, or even design improvements for future offshore wind turbines.

Safety Protocols Update: Based on insights from the system, regularly update safety protocols for maintenance teams, ensuring they are prepared for identified risks and potential issue

A computing system may be programmed with instructions that when executed produce the methods/algorithms according to aspects of the present invention.

As may be immediately appreciated, such a computer system may be integrated into another system such as a router and may be implemented via discrete elements or one or more integrated components. The computer system may comprise, for example, a computer running any of a number of operating systems. The above-described methods of the present disclosure may be implemented on the computer system as stored program control instructions.

Computer system includes processor, memory, storage device, and input/output structure. One or more input/output devices may include a display. One or more busses typically interconnect the components. Processor may be a single or multi core. Additionally, the system may include accelerators etc., further comprising the system on a chip.

Processor executes instructions in which embodiments of the present disclosure may comprise steps described in one or more of the Drawing figures. Such instructions may be stored in memory or storage device. Data and/or information may be received and output using one or more input/output devices.

Memory may store data and may be a computer-readable medium, such as volatile or non-volatile memory. Storage device may provide storage for system including for example, the previously described methods. In various aspects, storage device may be a flash memory device, a disk drive, an optical disk device, or a tape device employing magnetic, optical, or other recording technologies.

Input/output structures may provide input/output operations for system.

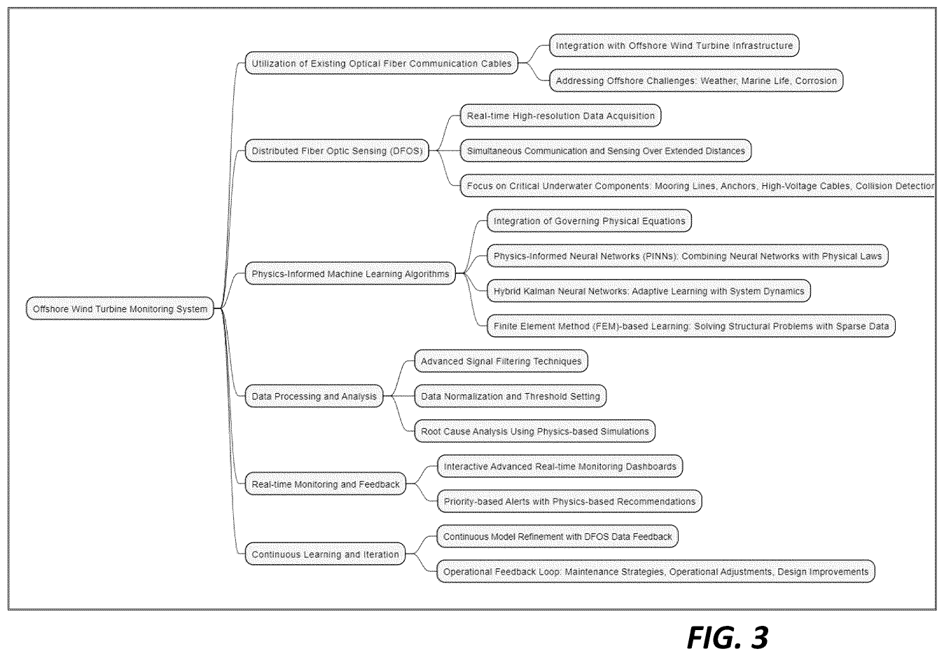

FIG. 3 is a schematic diagram showing illustrative features of systems and methods according to aspects of the present disclosure.

While we have presented our inventive concepts and description using specific examples, our invention is not so limited. Accordingly, the scope of our invention should be considered in view of the following claims.

1. An integrated distributed fiber optic sensing system for enhanced offshore wind turbine monitoring using physics-informed machine learning, the system comprising:
a distributed fiber optic sensing (DFOS) system for capturing temperature, acoustic, strain, or vibration data of the offshore wind turbines;
one or more physics-informed machine learning algorithms which are trained to determine, from the captured temperature, acoustic, strain, or vibration data, between routine operation and anomalies indicative of potential faults or damage to the wind turbines or components thereof.

2. The system of claim 1 wherein the physics-informed machine learning algorithms include physics-informed neural networks (PINNs) which incorporate governing physical equations directly into the PINN structure.

3. The system of claim 2 wherein the PINNs are trained with both historical data and synthetic data generated using physics-based simulations.

4. The system of claim 3 further comprising hybrid Kalman Neural Networks that provide real-time state estimation of wind turbine components.

5. The system of claim 4 wherein the PINNs are continuously refined using newly collected data from the DFOS system.
